(19) United States
(12) Patent Application Publication
(10) Pub. No.: US 2011/0097482 A1
(43) Pub. Date: Apr. 28, 2011

(54) COMPACT COATING SYSTEM AND PROCESS

(75) Inventors: Timothy S. December, Rochester Hills, MI (US); Daniel R. Waldon, Farmington Hills, MI (US)

(73) Assignee: BASF Coatings AG, Muenster (DE)

(21) Appl. No.: 12/606,704

(22) Filed: Oct. 27, 2009

(51) Int. Cl. B05B 5/00; C08L 33/00; C08L 33/04; C08L 33/14

(52) U.S. Cl. 427/160; 524/556; 524/522; 524/521

(57) ABSTRACT

A compact coating system comprises a UV-blocking coating composition, a basecoat composition, a clearcoat composition, and a monocoat topcoat composition, wherein: (a) each of the UV-blocking coating composition, the basecoat coating composition, and the monocoat coating composition comprises from about 0.1 to about 70%, based on total binder, of a first binder resin and (b) each of the monocoat coating composition and the clearcoat coating composition comprises from about 0.1 to about 50%, based on total binder, of a second binder resin. A method of coating automotive vehicle bodies includes applying the UV-blocking coating composition, the basecoat coating composition, and the clearcoat coating composition to a first vehicle body or part in a paint shop and applying the UV-blocking coating composition and the monocoat topcoat coating composition to a second vehicle body or part in the paint shop, wherein the monocoat coating composition is applied in a spraybooth where at least the clearcoat coating composition is also applied.

### FIELD OF THE INVENTION

The invention concerns coating processes for applying decorative and protective coatings. The invention particularly relates to such processes for applying industrial and automotive coatings.

### BACKGROUND OF THE DISCLOSURE

The statements in this section merely provide background information related to this disclosure and may not constitute prior art.

In a typical automotive coating process, there are many layers of coatings applied to the vehicle. Each coating layer is designed to impart certain properties to the coating system. A substrate is first coated with an electrocoat or electrodeposition (ED) coating. The ED coating is used for corrosion control. A primer/surfacer coating layer is usually applied over the ED coating layer at least in part to block ultraviolet (UV) rays in sunlight from reaching the ED layer. Over the primer layer, one or more basecoat layers are applied. Basecoats provide the desired color to the substrate. Over the basecoat layer, one or more clearcoat layers are applied. Clearcoats provide scratch resistance, mar resistance, environmental protection, gloss, and distinctness of image (DOI) to the basecoat.

Menovcik et al., US Patent Application Publication 2006/0121205 A describes an automotive coating process in which the primer/surfacer layer is eliminated, being replaced with a first, thin (up to 0.6 mil, 15.2 microns) basecoat layer that blocks UV light transmission through to the ED layer by incorporating a UV Mocking composition. The UV blocking composition includes two pigments selected from carbon black, iron oxide, titanium dioxide, and aluminum pigment.

### SUMMARY OF THE DISCLOSURE

The compact coating system comprises a UV-blocking coating composition, a basecoat composition, a clearcoat composition, and a monocoat topcoat composition. The UV-blocking coating composition is adapted to be applied in a layer between the electrocoat (or electrodeposition) primer or other primer layer and the topcoat layer or layers. The basecoat and clearcoat coating compositions are applied to together form a composite topcoat with color from the layer of basecoat coating composition and gloss and protection from the layer of clearcoat coating composition. The monocoat coating composition is applied as a one-layer topcoat that provides both the color and the gloss and protection features. The compact coating system layers can be applied in fewer booths and fewer applications because of interrelationships among the coating compositions of the system. Each of the UV-blocking coating composition, the basecoat coating composition, and the monocoat topcoat coating composition comprises from about 0.1 to about 70% by weight, based on total binder weight, of a first binder resin, and each of the monocoat topcoat coating composition and the clearcoat coating composition comprises from about 0.1 to about 50%, based on total binder, of a second binder resin. “Binder” refers to the film-forming components of the coating composition. “Binder resin” refers to a film forming resin having crosslinkable groups that react with a crosslinker of the binder during cure of the coating. It is believed that the shared resins provide necessary compatibility for spray application of a plurality of coating compositions of the compact coating system in a same spraybooth, as well as excellent wet-on-wet interlayer application characteristics and adhesion between the cured coating layers formed from the coating compositions of the compact coating system.

In various embodiments of the compact coating system the first binder resin may be from about 1 to about 60% by weight, based on total binder weight and/or the second binder may be from about 10 to about 50% by weight, based on total binder weight.

In each embodiment of the compact coating system, in combination with any of the described amounts of the first binder resin and the second binder resin, either or both of the first binder resin and the second binder resin can be an acrylic polymer and, in any of these various embodiments, if the first binder resin is an acrylic polymer it may have groups

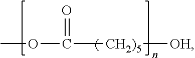

in which each n is independently 1, 2, 3, 4, or 5 and if the second binder resin is an acrylic polymer it may have carbamate groups.

The compact coating system is applied in an OEM automotive vehicle manufacturing plant's paint shop as the exterior finish of a vehicle or vehicle part. In the past, the paint shop area has been extensive, requiring (following the electrocoat coating area) a primer booth for a spray-applied primer-surfacer coating, an oven for curing the applied primer-surfacer coating, a basecoat spray zone followed by a drying tunnel, and a clearcoat spray zone and oven for curing the applied basecoat and clearcoat layers. A monocoat topcoat would need to be applied in still another spraybooth. The compact coating system allows a reduced area for finishing the vehicle with coating layers that may alternatively include a basecoat/clearcoat composite topcoat or a monocoat topcoat. The compact coating system also unexpectedly allows the elimination of the primer sanding deck.

In the methods of applying the coating compositions of the compact coating system in a paint shop, a first vehicle body is coated with the UV-blocking coating composition, the basecoat coating composition, and the clearcoat coating composition and a second vehicle body is coated with the LTV-blocking coating composition and the monocoat topcoat coating composition. The various coating compositions can be applied in the same spraybooth without cratering or other defects due to incompatibility, or all or any two of the UV-blocking coating composition, the basecoat coating composition, and the monocoat composition may be applied in a first spraybooth and the clearcoat composition and the monocoat composition may be applied in a second spraybooth. The compact coating system provides excellent intercoat adhesion between layers formed from its coating compositions and, therefore, allows more flexibility for in-line repair. For in-line repair using the compact coating system, a layer of a basecoat coating composition may be applied directly over any of another basecoat layer, a monocoat layer, or a clearcoat layer; a layer of a monocoat composition may be applied directly over a basecoat layer, a clearcoat layer, or another monocoat layer; and a layer of the clearcoat coating composition may be applied over a monocoat layer or a clearcoat layer.

The methods of coating automotive vehicle bodies with the compact coating system include applying a basecoat/clearcoat composite coating to a first vehicle body in a paint shop and applying a monocoat topcoat coating to a second vehicle body in the same paint shop. Both the clearcoat and the monocoat topcoat coating compositions are applied in a same spraybooth. In various embodiments, the method applies multilayer coating systems to two automotive vehicle bodies by first applying to the first vehicle an electrodeposition (ED) coating layer, applying over the ED layer at least one first pigmented, UV-blocking coating composition to form a UV-blocking layer that has a filmbuild up to about 30 microns and allows not more than about 0.5% ultraviolet light to pass through to the electrodeposition coating layer, applying over the UV-blocking layer at least one basecoat coating composition to form a basecoat layer on the UV-blocking layer, and applying at least one clearcoat coating composition over the basecoat layer to form a clearcoat layer on the basecoat layer; then, applying to the second vehicle an electrodeposition (ED) coating layer, then applying over the ED layer at least one first pigmented, UV-blocking coating composition to form a UV-blocking layer that has a filmbuild up to about 30 microns and allows not more than about 0.5% ultraviolet light to pass through to the electrodeposition coating layer, then applying one pigmented monocoat coating composition to form a monocoat layer on the first pigmented, UV-blocking layer. In various embodiments, the electrodeposition coating composition can be light gray, white, black, or another color; in each of the various embodiments, the electrodeposition coating composition can comprise electrodepositable resins selected from epoxy resins and acrylic polymers. In various embodiments of the first method, the first pigmented layer and the basecoat layer are applied in a first spraybooth of a paint line and the clearcoat layer and the monocoat layer are applied in a second spraybooth of a paint line. The basecoat coating composition contains a basecoat binder resin and a basecoat crosslinker; the UV-blocking coating composition comprises the basecoat binder resin, the basecoat crosslinker, and one or more UV-blocking pigments.

The methods of coating automotive vehicle bodies may employ one, two, or three separate spraybooths. In a first method, one spray booth with four spray application zones is used. The four zones are sequentially a first zone for applying the UV-blocking coating composition, a second zone for applying the basecoat coating composition, a third zone for applying the monocoat topcoat coating composition, and a fourth zone for applying the clearcoat coating composition. Vehicles may be coated by using the first and third zones to apply layers of the UV-blocking coating composition and the monocoat coating composition, or may be coated by using the first, second, and fourth zones to apply layers of the UV-blocking coating composition, the basecoat coating composition, and the clearcoat coating composition.

In a second method, two spray booths, each with two spray application zones, are used in series. In the second method, the first spraybooth has sequentially applications zones for the UV-blocking coating composition and for the basecoat coating composition. The second spray booth has spray application zones for the clearcoat coating composition and the monocoat topcoat coating composition, and either of these zones may be first in order in the spraybooth. In the method, a first vehicle is coated by applying to the vehicle a layer of the UV-blocking coating composition in the first spraybooth and a layer of the monocoat topcoat coating composition in the second booth; a second vehicle is coated by applying to the vehicle a layer of the UV-blocking coating composition and a layer of the basecoat coating composition in the first spraybooth and a layer of the clearcoat coating composition in the second booth.

In a third-method, three spray booths, a first booth with one spray zone and two subsequent booths in parallel with each other, with two spray zones each, are used. The UV-blocking coating composition is applied in the spray zone of the first spray booth. The second spraybooth has two spray zones, one in which the monocoat coating composition is applied and one in which the basecoat coating composition is applied. Either spray zone may be first. The third spraybooth has two spray zones, one in which the monocoat coating composition is applied and one in which the clearcoat coating composition is applied. Either spray zone may be first. A first vehicle is coated with a layer of the UV-blocking coating composition in the first spraybooth and a layer of the monocoat topcoat coating composition in either one of the second or the third spraybooths; a second vehicle is coated by applying to the vehicle a layer of the UV-blocking coating composition in the first spraybooth, a layer of the basecoat coating composition in the second spraybooth, and a layer of the clearcoat coating composition in the third spraybooth. When a vehicle coated with a layer of the basecoat coating composition is sent from the second spraybooth to the third booth to receive a layer of clearcoat coating composition, any vehicle exiting the first booth enters the second booth to receive either a layer of basecoat or a layer of monocoat coating composition.

Further provided in conjunction with the compact coating system are methods of in-line repair. In a method of in-line (or “high-bake”) repair, a partially coated vehicle body is placed in a line of the paint shop before a spraybooth. The repair coating may be (a) only a layer of the monocoat topcoat composition, or (b) both a layer of the UV-blocking coating composition and a layer of the monocoat topcoat composition, or (c) a layer of the basecoat composition and a layer of the clearcoat composition, or (d) a layer of the UV-blocking coating composition, a layer of the basecoat composition, and a layer of the clearcoat composition.

“A,” “an,” “the,” “at least one,” and “one or more” are used interchangeably to indicate that at least one of the item is present; a plurality of such items may be present. Other than in the working examples provides at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The disclosed methods will become more fully understood from the detailed description and the accompanying drawings, wherein:

FIG. 1 is a diagram illustrating a paint shop configuration for carrying out methods of the invention;

FIG. 2 is a process flow diagram illustrating how the paint shop configuration of FIG. 1 is used in coating vehicles;

FIG. 3 is a diagram illustrating an alternative paint shop configuration for carrying out methods of the invention;

FIG. 4 is a process flow diagram illustrating how the paint shop configuration of FIG. 3 is used in coating vehicles;

FIG. 5 is a diagram illustrating an alternative paint shop configuration for carrying out methods of the invention; and

FIG. 6 is a process flow diagram illustrating how the paint shop configuration of FIG. 5 is used in coating vehicles.

### DETAILED DESCRIPTION

The following description provides examples of limit the compact coating system and methods for its use.

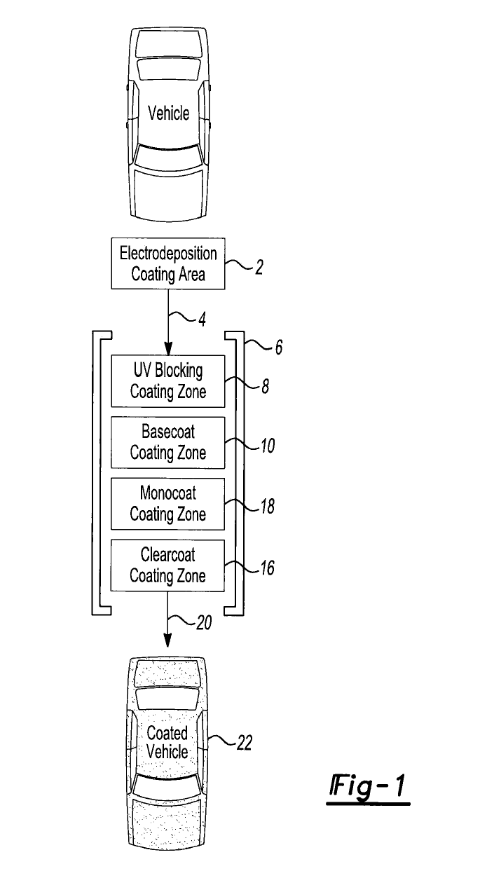

Referring first to the figures, in which like items have the same reference number throughout the various figures, FIG. 1 diagrams a paint line for carrying out the coating methods with the compact coating system. An electrodeposition coating layer is applied in electrodeposition coating area 2. The articles to be coated, such as automotive vehicle bodies, may first be treated in other ways before reaching the electrodeposition coating area, such as by cleaning and phosphating treatments. Typically, an electrodeposition priming process includes dipping the metal vehicle bodies into a tank containing aqueous electrodeposition coating composition, passing a current through the coating composition between an anode and the vehicle bodies (which are connected as the cathode of the electrical cell) to deposit an uncured electrodeposition coating layer onto the vehicle bodies, and rinsing the electrodeposited coating layer with deionized water. The vehicle bodies then pass out of the electrodeposition coating area, through an oven at arrow 4 where the uncured electrodeposition coating layer is cured, then through a cooling zone, also at arrow 4, and into a spraybooth 6.

Spraybooth 6 has four coating spray application zones. A layer of a different one of the coating compositions of the compact coating system is applied in each zone. In each zone, the coating composition layer may be applied in a single application layer (“one pass”) or may be applied in two sub-layers (“two passes”) that together form the coating layer. In this regard, none of the diagrams of the Figures is meant to represent lengths of the various coating zones relative to one another. In a first spray application zone 8, the UV blocking coating composition is applied to vehicle bodies. In a second spray application zone 10, the basecoat coating composition is applied to vehicle bodies. In a third spray application zone 18, the monocoat topcoat coating composition is applied to vehicle bodies. In a fourth spray application zone 16, the clearcoat coating composition is applied to vehicle bodies. While the spray application zone for applying the UV blocking coating composition is always first and the spray application zone for applying the basecoat coating composition always precedes the spray application zone for applying the clearcoat coating composition, the spray application zone for applying the monocoat coating composition may be before the spray application zone for applying the basecoat coating composition, between the spray application zones for applying the basecoat and clearcoat coating compositions as shown in FIG. 1, or after the spray application zone for applying the clearcoat coating composition. The spray zones may be spaced to allow for sufficient flash (evaporation of carrier liquid, e.g. organic liquid or water) between coating applications. In each case, the flash may be at ambient conditions, or may be heat-assisted, e.g. by installation of one or more infrared lamps. Generally, a short ambient flash is sufficient; the flash time may typically be from about 1 minute to about 15 minutes. At arrow 20 the vehicle bodies pass through a flash zone, which may optionally be a heated flash zone, and through an oven where the applied coating layers are cured to produce coated vehicles 22.

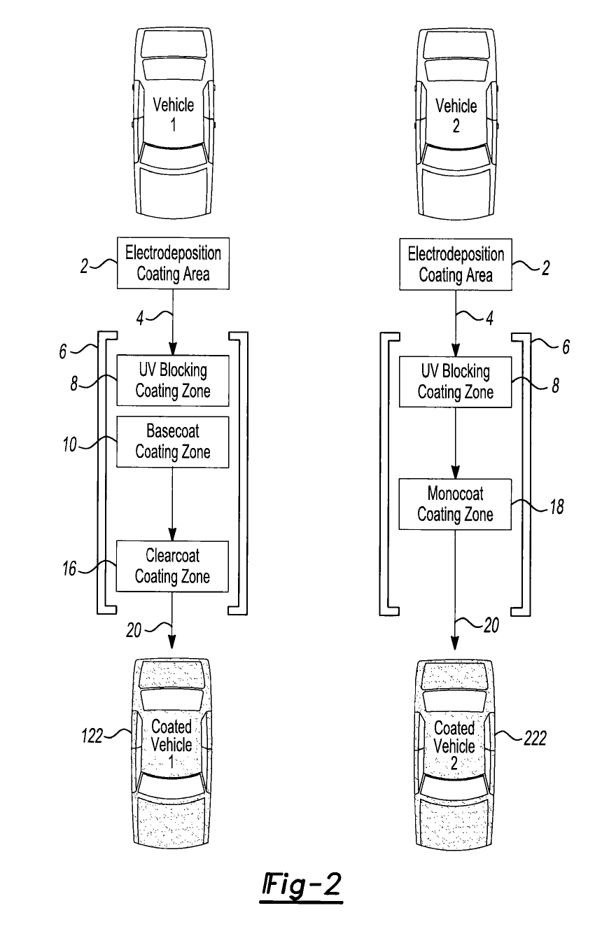

FIG. 2 shows side-by-side the parts of the paint line of FIG. 1 used in the first coating mode to coat a vehicle body 1 with a composite coating having basecoat and clearcoat topcoat layers (left side of FIG. 2) and the parts of the paint line used in second coating mode to coat a vehicle body 2 with a composite coating having a monocoat topcoat layer (right side of FIG. 2). In the process, a vehicle body 1 enters the electrodeposition coating area 2 where an electrodeposition coating composition is electrodeposited onto vehicle body 2 to form an electrodeposition coating layer, which is cured at arrow 4. The vehicle body 1 having a cured electrodeposition coating layer is cooled and then enters spraybooth 6, where a UV blocking coating composition is applied over the cured electrodeposition coating layer in zone 8 to form an uncured UV blocking coating layer and, after a desired, optional flash, basecoat coating composition is applied over the uncured UV blocking coating layer in zone 10 to form an uncured basecoat coating layer. Next, after a desired, optional flash, a clearcoat coating composition is applied over the uncured basecoat layer in clearcoat coating zone 16 to form an uncured clearcoat layer. (Nothing is applied where monocoat coating zone 18 is shown is FIG. 1.) The vehicle body 1 then passes out of spraybooth 6. At arrow 20 the vehicle body 1 passes through a flash zone, which may optionally be a heated flash zone, and through an oven where the applied coating layers are cured to produce coated vehicle 122.

Before or after vehicle 1 is coated to produce coated vehicle 122, a vehicle 2 is coated on the same paint line of FIG. 1. Vehicle body 2 enters the electrodeposition coating area 2 where an electrodeposition coating composition is electrodeposited to form an electrodeposition coating layer, which is cured at arrow 4. The vehicle body 2 having a cured electrodeposition coating layer is cooled and then enters spraybooth 6, where the UV blocking coating composition is applied over the cured electrodeposition coating layer in zone 8 to form an uncured UV blocking coating layer. After a desired, optional flash, a monocoat coating composition is applied over the uncured UV blocking coating layer in monocoat coating zone 18 to form an uncured monocoat layer. (Nothing is applied where basecoat coating zone 10 and clearcoat coating zone 16 are shown is FIG. 1.) The vehicle body 2 then passes out of spraybooth 6. At arrow 20 the vehicle body 2 passes through a flash zone, which may optionally be a heated flash zone, and through an oven where the applied coating layers are cured to produce coated vehicle 222.

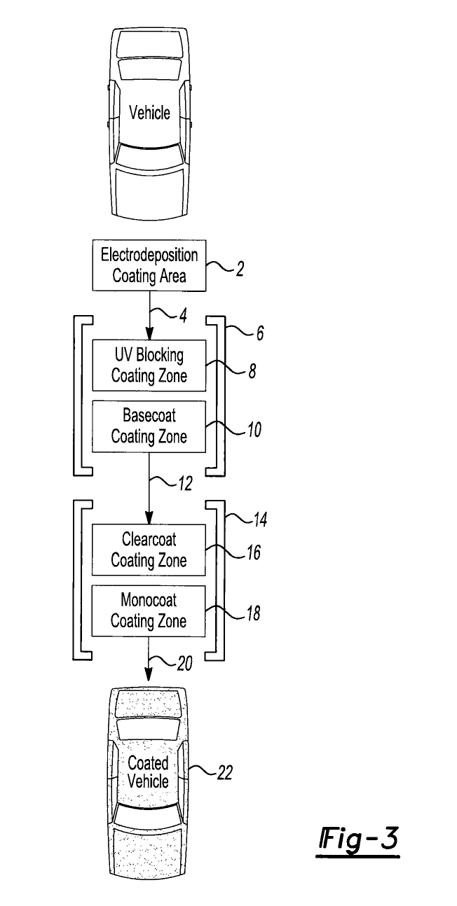

FIG. 3 diagrams an alternative embodiment of a paint line for carrying out the coating methods with the compact coating system. As in the first embodiment, an electrodeposition coating layer is applied to vehicle bodies in electrodeposition coating area 2, which may itself follow treatments such cleaning and phosphating operations. The electrodeposition priming process may be carried out as explained for FIG. 1, including coating deposition, rinsing, and passing through an oven at arrow 4 where the uncured electrodeposition coating layer is cured, then cooled. Next, the vehicle bodies or parts enter first spraybooth 6.

As in the first embodiment, in each zone for applying a coating composition of the compact coating process, the coating composition layer may be applied in a single application layer (“one pass”) or may be applied in two sub-layers (“two passes”) that together form the coating layer. First spraybooth 6 has two coating application zones. First spraybooth 6 is used in one way in a first coating mode and in a second way in a second coating mode. In the first coating mode, the UV blocking coating composition is applied to a vehicle body in coating zone 8 to form an uncured UV blocking coating layer over the cured electrodeposition primer layer, and in subsequent spray zone 10 a basecoat coating composition is applied to form an uncured basecoat layer over the uncured UV blocking coating layer. Spray zone 8 and spray zone 10 are spaced at a desired distance from one another in spraybooth 6 to allow a desired flash between application of the UV blocking coating composition and application of the basecoat coating composition. As in the methods already described, the flash may be at ambient conditions, or may be heat-assisted, e.g. by installation of one or more infrared lamps (here, in the area between zones 8 and 10). As in the methods already described, a short ambient flash is generally sufficient; the flash time may typically be from about 1 minute to about 15 minutes. In the second coating mode, a UV blocking coating composition is applied over the cured electrodeposition primer layer on the vehicle body in coating zone 8 to form an uncured UV blocking coating layer over the cured electrodeposition primer layer and nothing is applied in subsequent spray zone 10. The vehicle body, having both the uncured UV blocking coating layer and the uncured basecoat layer in the first coating mode or having only the uncured UV blocking coating layer in the second coating mode, then passes out of first spraybooth 6 on its way to second spraybooth 14. At arrow 12 between the two spraybooths, the vehicle body passes through a flash zone, which may optionally be a heated flash zone, optionally followed by a cooling zone. The vehicle body then passes into second spraybooth 14.

Second spraybooth 14 also has two coating zones. Second spraybooth 14 is used in one way in the first coating mode and in a second way in the second coating mode. In the first coating mode, a clearcoat coating composition is applied to the vehicle body in coating zone 16 to form an uncured clearcoat coating layer over the uncured basecoat coating layer. In the second coating mode, a monocoat coating composition is applied to the vehicle body in coating zone 18 to form an uncured monocoat coating layer over the cured UV blocking coating layer. FIG. 3 shows clearcoat coating zone 16 before monocoat coating zone 18 in the paint line, but the order may be reversed and monocoat coating zone 18 may precede clearcoat coating zone 16. The vehicle body, having either the uncured clearcoat coating layer in the first coating mode or having the uncured monocoat coating layer in the second coating mode, then passes out of second spraybooth 14. At arrow 20 the vehicle body passes through a flash zone, which may optionally be a heated flash zone, and through an oven where the applied coating layers are cured to produce coated vehicle 22. In the first coating mode, coated vehicle 22 will have an electrodeposition coating layer, a UV blocking coating layer, a basecoat coating layer, and a clearcoat coating layer. In the second coating mode, coated vehicle 22 will have an electrodeposition coating layer, a UV blocking coating layer, and a monocoat coating layer.

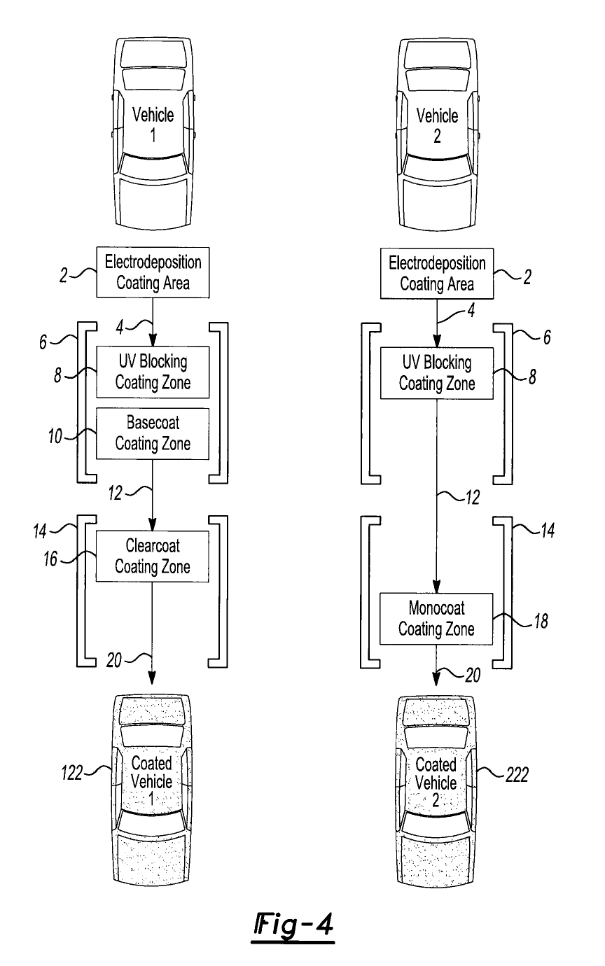

For this embodiment, FIG. 4 shows side-by-side the parts of the paint line used in the first coating mode to coat a vehicle body 1 with a basecoat/clearcoat composite topcoat (left side of FIG. 4) and the parts of the paint line used in second coating mode to coat a vehicle body 2 with a monocoat topcoat (right side of FIG. 4) using the arrangement of FIG. 3. In the process, a vehicle body 1 enters the electrodeposition coating area 2 where an electrodepositiion coating composition is electrodeposited onto vehicle body 2 to form an electrodeposition coating layer, which is cured at arrow 4. The vehicle body 1 having a cured electrodeposition coating layer is cooled and then enters spraybooth 6, where a UV blocking coating composition is applied over the cured electrodeposition coating layer in zone 8 to form an uncured UV blocking coating layer and, after a desired, optional flash, basecoat coating composition is applied over the uncured UV blocking coating layer in zone 10 to form an uncured basecoat coating layer. These uncured coating layers are allowed to flash at arrow 12 as the vehicle body 1 passes from spraybooth 6 into spraybooth 14. In spraybooth 14, a clearcoat coating composition is applied over the uncured basecoat layer in clearcoat coating zone 16 to form an uncured clearcoat layer. (As with FIG. 2, the unused coating zones are not shown; monocoat coating zone 18 as shown in FIG. 3 is not used to coat vehicle body 1 and so is not shown.) The vehicle body 1 then passes out of second spraybooth 14. At arrow 20 the vehicle body 1 passes through a flash zone, which may optionally be a heated flash zone, and through an oven where the applied coating layers are cured to produce coated vehicle 122.

Before or after vehicle 1 is coated to produce coated vehicle 122, a vehicle 2 is coated on the same paint line of FIG. 3. Vehicle body 2 enters the electrodeposition coating area 2 where an electrodeposition coating composition is electrodeposited to form an electrodeposition coating layer, which is cured at arrow 4. The vehicle body 2 having a cured electrodeposition coating layer is cooled and then enters spraybooth 6, where the UV blocking coating composition is applied over the cured electrodeposition coating layer in zone 8 to form an uncured UV blocking coating layer. The uncured coating layer is allowed to flash at arrow 12 as the vehicle body 2 passes from spraybooth 6 into spraybooth 14. In spraybooth 14, a monocoat coating composition is applied over the uncured UV blocking coating layer in monocoat coating zone 18 to form an uncured monocoat layer. The vehicle body 2 then passes out of second spraybooth 14. At arrow 20 the vehicle body 2 passes through a flash zone, which may optionally be a heated flash zone, and through an oven where the applied coating layers are cured to produce coated vehicle 222.

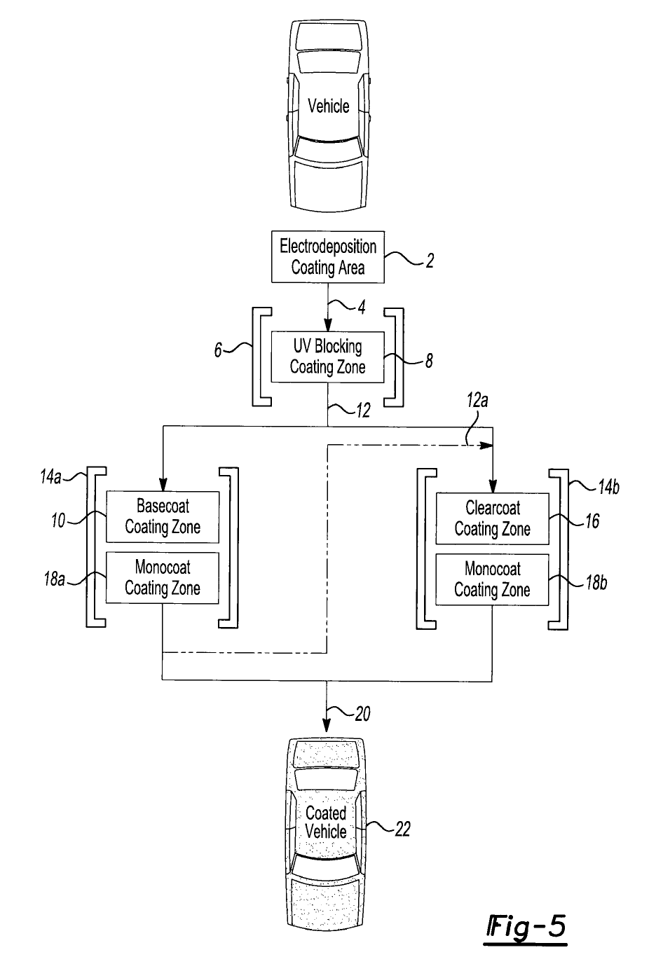

FIG. 5 diagrams another alternative embodiment for carrying out the coating methods with the compact coating system having two topcoat spraybooths making up two partial paint lines for the spray coating operations that share a common line for electrodeposition coating and coating with the UV blocking coating composition. As in the first two embodiments, an electrodeposition coating layer is applied in electrodeposition coating area 2, which may itself follow treatments such cleaning and phosphating operations. The electrodeposition priming process may be carried out as explained for FIG. 1, including coating deposition, rinsing, and passing through an oven at arrow 4 where the uncured electrodeposition coating layer is cured, then cooled. Next, the vehicle body or part enters first spraybooth 6.

As in the first two embodiments, in each zone for applying a coating composition of the compact coating process, the coating composition layer may be applied in a single application layer (“one pass”) or may be applied in two sub-layers (“two passes”) that together form the coating layer. First spraybooth 6 has one coating application zone for applying a UV blocking coating composition. First spraybooth 6 is used to apply UV blocking coating composition to each vehicle or part. The UV blocking coating composition is applied to the vehicle body or part in coating zone 8 to form an uncured UV blocking coating layer over the cured electrodeposition primer layer. The vehicle body or part having the uncured UV blocking coating layer then passes out of first spraybooth 6 on its way to either second spraybooth 14a or third spraybooth 14b. At arrow 12 between the two spraybooths, the vehicle body passes through a flash zone, which may optionally be a heated flash zone, optionally followed by a cooling zone. The vehicle body or part then passes into one of the spraybooths 14a or 14b.

The choice of whether to have the vehicle body or part enter spraybooth 14a or 14b will depend on the topcoat that is to be applied. If a basecoat-clearcoat composite topcoat is to be applied, then the vehicle body or part must first enter spraybooth 14a to receive a basecoat layer and then be routed to enter spraybooth 14b to receive a clearcoat layer. If a monocoat topcoat is to be applied, the vehicle or part may enter either spraybooth 14a or spraybooth 14b, and one of 14a or 14b may be selected depending on factors such as efficiency, e.g., the other booth already is being used to paint another vehicle body or part or each booth is used only for certain colors.

Spraybooth 14a has two coating zones, basecoat coating zone 10 in which a basecoat coating composition is applied to form an uncured basecoat layer over the uncured UV blocking coating layer and monocoat coating zone 18a in which a monocoat coating composition is applied to form an uncured monocoat topcoat layer over the cured UV blocking coating layer. FIG. 5 shows the basecoat coating zone before the monocoat coating zone, but either zone may be first and the other second in order. The vehicle body, having both the uncured UV blocking coating layer and the uncured basecoat layer in the first coating mode or having the uncured UV blocking coating layer and the uncured monocoat layer in the second coating mode, then passes out of second spraybooth 14a. In the second coating mode, when the vehicle body or part has the uncured monocoat coating layer, it passes to arrow 20.

In the first coating mode, when the vehicle body has both the uncured UV blocking coating layer and the uncured basecoat layer, the vehicle body is routed along path 12a to enter third spraybooth 14b. Path 12a may include a flash zone, which may optionally be a heated flash zone, optionally followed by a cooling zone. Third spraybooth 14b also has two coating zones. Third spraybooth 14b is used in the first coating mode to apply a clearcoat coating composition to the vehicle body in clearcoat coating zone 16 to form an uncured clearcoat coating layer over the uncured basecoat coating layer. The vehicle then passes to arrow 20.

In an alternative second coating mode, the vehicle body or part having an uncured UV blocking coating layer after leaving spraybooth 8 enters spraybooth 14b, where a monocoat coating composition is applied to the vehicle body in monocoat coating zone 18b to form an uncured monocoat coating layer over the cured UV blocking coating layer. FIG. 5 shows clearcoat coating zone 16 before monocoat coating zone 18b in spraybooth 14b, but the order may be reversed and monocoat coating zone 18b may precede clearcoat coating zone 16. The vehicle body, having the uncured monocoat coating layer, then passes to arrow 20.

At arrow 20 the vehicle body passes through a flash zone, which may optionally be a heated flash zone, and through an oven where the applied coating layers are cured to produce coated vehicle 22. In the first coating mode, coated vehicle 22 will have an electrodeposition coating layer, a UV blocking coating layer, a basecoat coating layer, and a clearcoat coating layer. In either of the alternative second coating modes, coated vehicle 22 will have an electrodeposition coating layer, a UV blocking coating layer, and a monocoat coating layer.

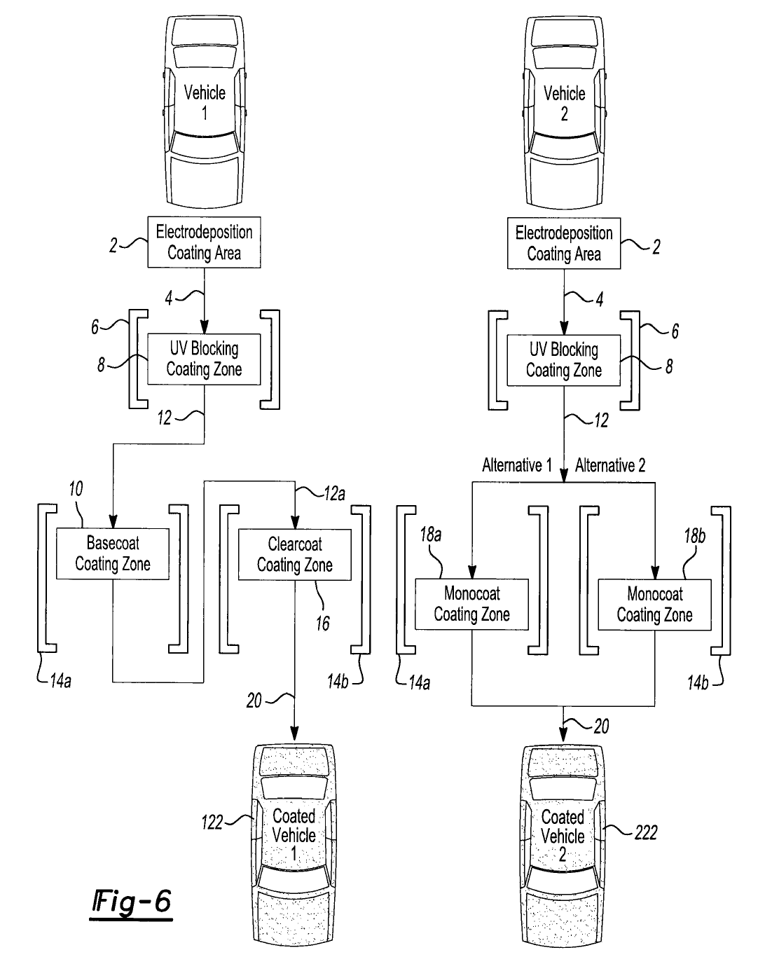

For this embodiment, FIG. 6 shows side-by-side the parts of the paint line used in the first coating mode to coat a vehicle body 1 with a basecoat/clearcoat topcoat (left-hand side) and the parts of the paint line used in second coating mode to coat a vehicle body 2 with a monocoat topcoat (right-hand side) using the embodiment of FIG. 5. In the process, a vehicle body 1 that will be coated in the first coating mode enters the electrodeposition coating area 2 where an electrodeposition coating composition is electrodeposited onto vehicle body 2 to form an electrodeposition coating layer, which is cured at arrow 4. These process are carried out as previously described. The vehicle body 1 having a cured electrodeposition coating layer is cooled and then enters spraybooth 6, where a UV blocking coating composition is applied over the cured electrodeposition coating layer in UV blocking coating zone 8 to form an uncured UV blocking coating layer. The vehicle body 1 then, after a desired, optional flash at arrow 12, passes into spraybooth 14a where a basecoat coating composition is applied over the uncured UV blocking coating layer in basecoat coating zone 10 to form an uncured basecoat coating layer. The uncured basecoat coating layer is allowed to flash at arrow 12a as the vehicle body 1 passes from spraybooth 14a into spraybooth 14b. In spraybooth 14b, a clearcoat coating composition is applied over the uncured basecoat layer in clearcoat coating zone 16 to form an uncured clearcoat layer. The vehicle body 1 then passes out of spraybooth 14b. At arrow 20 the vehicle body 1 passes through a flash zone, which may optionally be a heated flash zone, and through an oven where the applied coating layers are cured to produce coated vehicle 122.

Before or after vehicle 1 is coated to produce coated vehicle 122, a vehicle 2 is coated in the second coating mode using the same embodiment of FIG. 5. Vehicle body 2 enters the electrodeposition coating area 2 where an electrodeposition coating composition is electrodeposited to form an electrodeposition coating layer, which is cured at arrow 4. These processes are carried out as already described. The vehicle body 2 having a cured electrodeposition coating layer is cooled and then enters spraybooth 6, where the UV blocking coating composition is applied over the cured electrodeposition coating layer in UV blocking coating zone 8 to form an uncured UV blocking coating layer. The uncured coating layer is allowed to flash at arrow 12 as the vehicle body 2 passes from spraybooth 6 into spraybooth 14a (in Alternative 1) or, alternatively, into spraybooth 14b (in Alternative 2). In whichever spraybooth the vehicle body or part enters, spraybooth 14a or spraybooth 14b, a monocoat coating composition is applied over the uncured UV blocking coating layer. The monocoat coating composition is applied over the uncured UV blocking coating layer in monocoat coating zone 18a if the vehicle body or part enters spraybooth 14a, or the monocoat coating composition is applied over the uncured UV blocking coating layer in monocoat coating zone 18b if the vehicle body or part enters spraybooth 14b, in each case forming an uncured monocoat layer. The vehicle body 2 then passes out of the spraybooth. At arrow 20 the vehicle body 2 passes through a flash zone, which may optionally be a heated flash zone, and through an oven where the applied coating layers are cured to produce coated vehicle 222.

The electrodeposition composition can be any electrodeposition composition used in automotive vehicle coating operations. In each of the various embodiments, the electrodeposition coating composition can comprise electrodepositable resins selected from epoxy resins and acrylic polymers. Non-limiting examples of electrocoat compositions include the CATHOGUARD® electrocoating compositions sold by BASF Corporation, such as CATHOGUARD® 500. Electrodeposition coating baths usually comprise an aqueous dispersion or emulsion including a principal film-forming selected from epoxy resins and acrylic polymers having ionic stabilization (e.g., salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents, include, without limitation, blocked polyisocyanates. The electrodeposition coating compositions usually include one or more pigments, catalysts, plasticizers, coalescing aids, antifoaming aids, flow control agents, wetting agents, surfactants, UV absorbers, HALS compounds, antioxidants, and other additives. The electrodeposition coating composition can be light gray, white, black, or another color.

The electrodeposition coating composition is preferably applied to a dry film thickness of 10 to 35 μm. After application, the coated vehicle body is removed from the bath and rinsed with deionized water. The coating may be cured under appropriate conditions, for example by baking at from about 275° F. to about 375° F. (about 135° C. to about 190° C.) for between about 15 and about 60 minutes.

Each of the UV-blocking coating composition, the basecoat coating composition, and the monocoat topcoat coating composition comprises from about 0.1 to about 70%, based on total binder, of a first binder resin, and each of the monocoat topcoat coating composition and the clearcoat coating composition comprises from about 0.1 to about 50%, based on total binder, of a second binder resin. In various embodiments, each of the UV-blocking coating composition, the basecoat coating composition, and the monocoat topcoat coating composition comprises from about 1 to about 60%, based on total binder, of the first binder resin. In each of the embodiments, the first binder resin may be an acrylic polymer, and in each embodiment the acrylic polymer may be a hydroxyl-functional acrylic polymer having groups with a structure

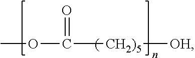

in which each n is independently 1, 2, 3, 4, or 5, particularly in which each n is independently 1, 2, or 3, and especially in which each n is independently 1 or 2. In various embodiments, the monocoat topcoat coating composition and the clearcoat coating composition both comprises from about 10 to about 50%, based on total binder, of the second binder resin. In each of the embodiments, the second resin may be an acrylic polymer, and in each embodiment the acrylic polymer may be a carbamate-functional acrylic polymer. Carbamate groups can be represented by the structure

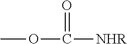

in which R is H or alkyl, preferably of 1 to 4 carbon atoms. Preferably R is H or methyl, and more preferably R is H. In the various embodiments, the acrylic polymer may be prepared by copolymerization of a hydroxyl-functional (meth)acrylate with comonomers selected from alkyl (meth)acrylates and other vinyl monomers, including styrene, with the hydroxyl groups of the acrylic polymer being reacted with methyl carbamate to provide carbamate groups. “(Meth)acrylate” is used to refer to acrylate and/or methacrylate.

In general, the basecoat composition comprises a basecoat binder resin, a basecoat crosslinker, an organic or aqueous liquid (the “solvent” or “solvent system”), and one or more pigments. The basecoat binder resin has crosslinkable groups and the basecoat crosslinker has a plurality of functional groups that react with the crosslinkable groups in the oven at arrow 20. The basecoat coating composition may include a mixture of crosslinkable resins, but the basecoat coating composition includes at least the first binder resin that is also in the UV-blocking coating composition and the monocoat topcoat coating composition.

Nonlimiting examples of basecoat binder resins which may be the first resin or may be combined with the first resin in the basecoat coating composition include acrylics, vinyls, polyurethanes, polycarbonates, polyesters, alkyds, polyepoxy and polysiloxanes as well as resins that are modified with or combinations of these. Nonlimiting examples of the crosslinkable groups are hydroxyl, carbamate, carboxyl, epoxide, anhydride, blocked isocyanate, silane, and acetoacetate groups and compatible combinations of these. Suitable basecoat crosslinkers depend on the type of crosslinkable groups on the basecoat resin or polymer. These groups may be masked or blocked in such a way so that they are unblocked and available for the crosslinking reaction under the desired curing conditions, generally at elevated temperatures. Nonlimiting examples of basecoat crosslinkers that may be used include blocked polyisocyanates (reactive with hydroxyl groups), in which the isocyanate groups are blocked with a group that will de-block at the desired cure temperature, aminoplast crosslinkers (reactive with hydroxyl, carboxylic acid, and carbamate groups), polyepoxide crosslinkers (reactive with carboxylic acid groups), hydroxyl (reactive with blocked isocyanate and anhydride groups), and polycarboxylic acids (reactive with epoxide groups). Useful aminoplast crosslinkers include, without limitation, materials having active methylol or methylalkoxy groups. Nonlimiting examples of such crosslinkers include melamine formaldehyde crosslinkers, including monomeric or polymeric melamine formaldehyde resin and partially or fully alkylated melamine formaldehyde resin, urea resins, and methylol ureas such as urea formaldehyde resin, alkoxy ureas such as butylated urea formaldehyde resin. Other nonlimiting examples of such crosslinkers include blocked isocyanates include blocked aliphatic polyisocyanates and biurets, isocyanurates, isocyanate-functional reaction products of polyols, and other isocyanate-functional reaction products of aliphatic polyisocyanates.

The basecoat coating composition may include a catalyst to enhance the cure reaction. For example, especially when monomeric melamines are used as a curing agent, a strong acid catalyst may be utilized to enhance the cure reaction. Such catalysts are well-known in the art and include, without limitation, p-toluene sulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine. For the reaction of polyisocyanates with suitable functionalities, suitable catalysts include tin compounds such as dibutyl tin dilaurate, dibutyl tin diacetate, dibutyl tin oxide, tertiary amines, zinc salts, and manganese salts. Reactions between epoxide and carboxyl groups may be catalyzed with tertiary amines or quaternary ammonium salts (e.g., benzyldimethylamine, dimethylaminocyclohexane, triethylamine, N-methylimidazole, tetramethyl ammonium bromide, and tetrabutyl ammonium hydroxide.), tin and/or phosphorous complex salts (e.g., (CH₃)₃ SNI, (CH₃)₄ PI, triphenylphosphine, ethyltriphenyl phosphonium iodide, tetrabutyl phosphonium iodide) and so on.

A solvent or solvents may be included in the coating composition. In general, the solvent can be any that does not interfere in the crosslinking reactions. In one preferred embodiment, the solvent includes a polar organic solvent. More preferably, the solvent includes one or more organic solvents selected from polar aliphatic solvents or polar aromatic solvents. Still more preferably, the solvent includes a ketone, ester, acetate, or a combination of any of these. Suitable solvents include, without limitation, organic solvent such as a ketone, including methyl isobutyl ketone and methyl amyl ketone, aromatic solvents such as toluene, xylene, Aromatic 100, and Aromatic 150, and esters, such as butyl acetate, n-propyl acetate, hexyl acetate; water, which may be combined with such organic cosolvents typically used in aqueous coating compositions, such as water-soluble and water-miscible alcohols, glycol ethers and glycol ether esters.

Additional agents, for example surfactants, stabilizers, wetting agents, rheology control agents, dispersing agents, adhesion promoters, fillers, UV absorbers, hindered amine light stabilizers, etc. may be incorporated into the basecoat coating composition.

The basecoat composition includes one or more pigments to provide a basecoat layer of a desired color. The pigment may be any organic or inorganic compounds or colored materials, metallic or other inorganic flake materials such as pearlescent mica flake pigments or metallic flake pigments such as aluminum flake, and other materials of kind that the art normally includes in such coatings. Fillers may optionally be included in addition to pigment. Inorganic pigments include metal oxides, chromates, molybdates, phosphates, and silicates. Suitable, nonlimiting examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and mica flake pigments. Organic pigments may also be used. Nonlimiting examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like. Pigments and other insoluble particulate compounds such as fillers are usually used in the composition in an amount of 1% to 100%, based on the total solid weight of binder components (i.e., a pigment-to-binder ratio of 0.1 to 1). The basecoat composition is applied in an amount so that the cured basecoat layer exhibits a desired color development. In general, the basecoat layer may be from about 0.3 mils (about 7.6 micrometers) to about 1.3 mils (about 33 micrometers) thick.

The UV blocking coating composition comprises the first binder resin, at least one UV blocking pigment selected from the group consisting of carbon black, iron oxide, titanium dioxide, and aluminum pigment, and combinations of these, and, optionally, a crosslinker that is present in the basecoat coating composition. In the various embodiments, the UV blocking coating composition may comprise 45 to 60%, based on total binder, of the first binder resin. The UV-blocking coating composition has a sufficient amount of UV blocking pigment so that a layer that has a filmbuild up to about 30 microns allows not more than about 0.5% ultraviolet light to pass through to the electrodeposition coating layer (that is, transmission of not more than about 0.5% at 400 nm wavelength). The pigments used as UV blockers may be included at a pigment to binder weight ratio of between about 0.30 to about 0.50. The total pigment concentration based on total weight of the nonvolatile coating components may be from about 10% to about 18% by weight.

The carbon black can be any carbon black pigment used for coating compositions. The carbon black is present in the first basecoat coating when used in combination with the other pigments in an amount to provide the desired reduction in ultraviolet light transmittance. The carbon black may be present in the basecoat composition in an amount from about 0.1 wt. % up to about 10 wt. % by weight of pigment. In one embodiment, the carbon black is utilized in an amount from about 0.05 to about 1.0 wt. % by weight of pigment. The carbon black may be present in an amount from about 0.05 to about 5.0 wt. % by weight of the nonvolatile coating materials, or from about 0.05 to about 1.0 wt. % by weight of the nonvolatile coating materials, or from about 0.22 to about 5.0 wt. % by weight of the nonvolatile coating materials.

The iron oxide can be any iron oxide pigment used for coating compositions. Examples of iron oxides include, but are not limited to, SICOTRANS® RED L2818 red iron oxide, KROMA® RED R03097, SICOTRANS® yellow 1916 yellow iron oxide, MAPICO® yellow 1050 yellow iron oxide. In some embodiments, red iron oxide performs better than yellow iron oxide. In various embodiments, the iron oxide may be present in an amount from about 5% to about 70% by weight of pigment. In the coating composition, the iron oxide may be present in an amount from about 0.5 to about 20% by weight of nonvolatile coating components, or from about 5 to 10% by weight of nonvolatile coating components.

The titanium dioxide can be any titanium dioxide pigment used for coating compositions. Examples of titanium dioxides include, but are not limited to, TI-Pure® R-706 titanium dioxide and Micro® MT 500SA titanium dioxides. The titanium dioxide is present in any desired amount. In various embodiments, the titanium dioxide is present in the basecoat composition in an amount from about 5% to about 75% by weight of pigment solids. In the cured coating, the titanium dioxide is present in an amount from about 5 to about 40 weight % by weight of nonvolatile coating components, or from about 20 to 30 wt. % by weight by weight of nonvolatile coating components.

Effective aluminum pigments are those that can block UV light. Corn flake-shaped aluminum pigment generally performs better than silver dollar-shaped aluminum pigment. Nonlimiting examples of suitable aluminum pigments include STAPA® Metallic 801 from Eckart, TOYO® aluminum 8160N-AR, STAPA® 1515NL from Eckart, STAPA® Metallux 2156 from Eckart, SDS8-335 Aluminum. and other aluminum flake pigments. Optionally, the aluminum pigment can be coated. In various embodiments, the aluminum pigment is present in an amount from about 1.0% to about 70 wt. % by weight of pigment. In the coating composition, the aluminum pigment may be present in an amount from about 3.0 to about 20.0 weight % by weight of the nonvolatile coating components, or from about 5 to 20% by weight of the nonvolatile coating components.

In addition to the first binder resin, the UV blocking coating composition may include one or more additional binder resins and crosslinkers, such as any of those already mentioned as useful in the basecoat coating composition, that are not also in the basecoat coating composition, or the UV blocking coating composition may include only binder resin(s) and crosslinker(s) that are also in the basecoat coating composition.

The UV blocking coating composition further may contain any of the other materials mentioned as suitable for the basecoat coating composition, for example catalysts and additives.

The UV blocking coating composition may include a pigment or pigments other than the UV blocking pigment, nonlimiting examples of which are those mentioned as suitable for the basecoat composition. In various embodiments, the UV blocking coating composition may includes a pigment or pigments also present in the basecoat coating composition. The basecoat composition and the UV blocking coating composition have different pigment compositions, either because different pigments are in the basecoat and UV blocking coating compositions or different amounts of the same pigments are in the basecoat and UV blocking coating compositions or both.

The UV blocking layer is typically applied in an amount so that the cured UV blocking layer has a filmbuild up to about 30 micrometers (about 1.2 mils). The UV blocking coating layer is thick enough to block UV light from reaching the electrocoat primer layer.

The clearcoat coating composition comprises a clearcoat binder resin, a clearcoat crosslinker, and an organic or aqueous solvent. The clearcoat composition can be any clearcoat composition used for automotive coatings. In various embodiments, the clearcoats include any of the kinds of resins with any of the kinds of crosslinkable groups and appropriate crosslinkers mentioned as useful in the basecoat compositions.

Such clearcoats can be formulated as one package systems or as two package (or 2K) systems, in which the crosslinkable resin(s) and the crosslinker(s) are segregated into separate packages and combined only just prior to application. In various embodiments, the clearcoats can be solventbome (i.e., in an organic liquid medium), waterborne (aqueous, including powder slurries) or powder clearcoats. Nonlimiting examples of solvent and other clearcoat components include any of those mentioned already in connection with basecoat compositions. Examples of commercially available clearcoat compositions are UNIGLOSS®, DURAGLOSS®, STARGLOSS®, UREGLOSS®, EVERGLOSS®, PROGLOSS®, TWINGLOSS®, SLURRYGLOSS®, and CLEANGLOSS®, all available from BASF Corporation.

The monocoat coating composition comprises both the first binder resin and the second binder resin. In various embodiments, the monocoat coating composition may comprises from about 5 to 10%, based on total binder, of the first binder resin and from about 15 to 25%, based on total binder, of the second binder resin. The monocoat coating composition may comprise one or more other resins also present in the clearcoat coating composition, and in various embodiments the monocoat coating composition further comprises at least the clearcoat crosslinker. Additionally, the monocoat coating composition includes an organic or aqueous solvent and one or more pigments. The pigment or pigments may be selected from any of those mentioned as suitable pigments for the basecoat composition. In various embodiments, the first binder resin or one of the first binder resins is a resin used to disperse one or more of the pigments In various embodiments, the second binder resin comprises an acrylic resin or polyurethane resin having crosslinkable groups selected from hydroxyl, carbamate, and carboxyl groups and combinations of these.

The monocoat layer is applied in an amount so that the cured monocoat layer exhibits a desired color development. In general, the monocoat layer may be from about 25 micrometers (about 0.8 mil) to about 76 micrometers (about 3 mils) thick.

The coating compositions can be coated on a substrate by spray coating. Electrostatic spraying is a preferred method. The coating composition can be applied in one or more passes to provide a film thickness after cure of typically from about 20 to about 100 microns.

After application of all the spray-applied coating layers, the coating layers are cured together, preferably by exposing the coating layer to heat for a length of time sufficient to fully cure the coating layers. The cure temperature is usually from about 105° C. to about 175° C., and the length of cure is usually about 15 minutes to about 60 minutes. Preferably, the coating is cured at about 120° C. to about 150° C. for about 20 to about 30 minutes.

The various features of the compact coating system can be used in any combination in any of the methods described above.

The description is merely exemplary in nature and, thus, variations that do not depart from the gist of the disclosure are a part of the invention. Variations are not to be regarded as a departure from the spirit and scope of the disclosure.

What is claimed is:

1. A compact coating system, comprising a UV-blocking coating composition, a basecoat composition, a clearcoat composition, and a monocoat topcoat composition, wherein:
(a) each of the UV-blocking coating composition, the basecoat coating composition, and the monocoat coating composition comprises from about 0.1 to about 70% by weight, based on total binder weight, of a first binder resin and
(b) each of the monocoat coating composition and the clearcoat coating composition comprises from about 0.1 to about 50% by weight, based on total binder weight, of a second binder resin.

2. A compact coating system according to claim 1, wherein each of the UV-blocking coating composition, the basecoat coating composition, and the monocoat topcoat coating composition comprises from about 1 to about 60% by weight, based on total binder weight, of the first binder resin.

3. A compact coating system according to claim 1, wherein the first binder resin is an acrylic polymer.

4. A compact coating system according to claim 3, wherein the acrylic polymer comprises groups 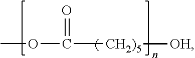
in which each n is independently 1, 2, 3, 4, or 5.

5. A compact coating system according to claim 4, wherein each n is independently 1, 2, or 3.

6. A compact coating system according to claim 1, wherein each of the monocoat coating composition and the clearcoat coating composition comprises from about 10 to about 50% by weight, based on total binder weight, of the second binder resin.

7. A compact coating system according to claim 1, wherein the second binder resin is an acrylic polymer.

8. A compact coating system according to claim 7, wherein the acrylic polymer is carbamate-functional.

9. A method of coating, in a paint shop, automotive vehicle bodies or parts with the compact coating system of claim 1, comprising
applying in the paint shop the UV-blocking coating composition, the basecoat coating composition, and the clearcoat coating composition to a first vehicle body or part and applying in the paint shop the UV-blocking coating composition and the monocoat topcoat coating composition to a second vehicle body or part in the paint shop,
wherein the monocoat coating composition and the clearcoat coating composition are in applied in a same spraybooth.

10. A method of coating automotive vehicle bodies or parts according to claim 9, comprising
(a) coating a first vehicle body or part by, in a first spraybooth, applying to the first vehicle body or part the UV-blocking coating composition to form an uncured UV blocking coating layer and then applying the basecoat coating composition to form an uncured basecoat layer over the uncured UV-blocking coating layer; in a second spraybooth, applying the clearcoat coating composition over the uncured basecoat layer to form an uncured clearcoat layer; and curing the uncured UV-blocking coating layer, the uncured basecoat layer, and the uncured clearcoat layer to produce a first coated vehicle body or part, and
(b) coating a second vehicle body or part by, in the first spraybooth, applying to the second vehicle body or part the UV-blocking coating composition to form an uncured UV blocking coating layer; in the second spraybooth, applying the monocoat topcoat coating composition over the uncured UV-blocking layer to form an uncured monocoat topcoat layer; and curing the uncured UV-blocking coating layer and the uncured monocoat topcoat layer to produce a second coated vehicle body or part.

11. A method of coating automotive vehicle bodies or parts according to claim 9, comprising
in a spraybooth having a first spray zone for applying the UV-blocking coating composition, a second spray zone for applying the basecoat coating composition, a third spray zone for applying the monocoat topcoat coating composition, and a fourth spray zone for applying the clearcoat coating composition,
(a) applying to a first vehicle body or part the UV-blocking coating composition to form an uncured UV blocking coating layer, applying the basecoat coating composition to form an uncured basecoat layer over the uncured UV-blocking coating layer, and applying the clearcoat coating composition over the uncured basecoat layer to form an uncured clearcoat layer; then curing the uncured UV-blocking coating layer, the uncured basecoat layer, and the uncured clearcoat layer to produce a first coated vehicle body or part, and
(b) applying to a second vehicle body or part the UV-blocking coating composition to form an uncured UV blocking coating layer and applying the monocoat topcoat coating composition over the uncured UV-blocking layer to form an uncured monocoat topcoat layer; then curing the uncured UV-blocking coating layer and the uncured monocoat topcoat layer to produce a second coated vehicle body or part.

12. A method of coating automotive vehicle bodies or parts according to claim 9, comprising
(a) coating a first vehicle body or part by, in a first spraybooth, applying to the first vehicle body or part the UV-blocking coating composition to form an uncured UV blocking coating layer; in a second spraybooth having a spray zone for the basecoat coating composition and a spray zone for the monocoat coating composition, applying the basecoat coating composition to form an uncured basecoat layer over the uncured UV-blocking coating layer; in a third spraybooth having a spray zone for the clearocat coating composition and a spray zone for the monocoat coating composition, applying the clearcoat coating composition over the uncured basecoat layer to form an uncured clearcoat layer; and curing the uncured UV-blocking coating layer, the uncured basecoat layer, and the uncured clearcoat layer to produce a first coated vehicle body or part, and
(b) coating a second vehicle body or part by, in the first spraybooth, applying to the second vehicle body or part the UV-blocking coating composition to form an uncured UV blocking coating layer; in one of the second spraybooth or the third spraybooth, applying the monocoat topcoat coating composition over the uncured UV-blocking layer to form an uncured monocoat topcoat layer; and curing the uncured LTV-blocking coating layer and the uncured monocoat topcoat layer to produce a second coated vehicle body or part.
